(19) United States
(12) Patent Application Publication
(10) Pub. No.: US 2009/0325624 A1
(43) Pub. Date: Dec. 31, 2009

(54) LOAD DISTRIBUTION AMONG BASE STATIONS THROUGH TRANSMIT POWER VARIATION

(75) Inventor: Angelo Centonza, Winchester (DE)

Correspondence Address: STAAS & HALSEY LLP, SUITE 700, 1201 NEW YORK AVENUE, N.W., WASHINGTON, DC, 20005, US

(73) Assignee: Nokia Siemens Networks GmbH & Co., KG, Munich (DE)

(21) Appl. No.: 12/449,109

(22) PCT Filed: Jan. 14, 2008
(86) PCT No.: PCT/EP2008/050345

§ 371 Date: Jul. 23, 2009

(30) Foreign Application Priority Data
Jan. 23, 2007 (GB) 0701243.8

(51) Int. Cl. H04B 7/00

(52) U.S. Cl. 455/522

(57) ABSTRACT

A method of load distribution between a first base station and a second base station determines in a user device, that the first and second base stations are simultaneously within range of the user device. The user device is set as a bridge. Load factors and available resources of each base station within range of the bridge user device are provided. A first, less loaded base station increases its power until the power of the first base station is within a predetermined range of the power of a second, more loaded base station.

### CROSS REFERENCE TO RELATED APPLICATIONS

This application is based on and hereby claims priority to PCT Application No. PCT/EP2008/050345 filed on Jan. 14, 2008 and GB Application No. 0701243.8 filed on Jan. 23, 2007, the contents of which are hereby incorporated by reference.

### BACKGROUND OF THE INVENTION

This invention relates to a method of load distribution between base stations.

Operators of mobile communications systems, such as universal mobile telecommunications system (UMTS) are investigating so called home base stations, intended to be plug and play base stations that are installed by a user for use in a limited area, typically within a home, without being subject to coverage tuning resulting from network planning. This provides savings by avoiding the need for skilled workers to set up correct positions for base stations within the network.

Each base station is set to cover a default area when issued to the user, which may possibly overlap to some extent with adjacent home base station cells which have already been installed by other users. As a result, it is difficult to optimise home base station coverage and increases the handover frequency for those terminals located within an overlap region.

Furthermore, the fact that home base stations cannot adjust their cell coverage according to the status of the network, means that there is no scope for sharing cell traffic between adjacent cells. Home base stations could also be deployed in business environments such as offices, conference centres etc., which might also give rise to one home base station cell being subject to overloading, due to the high number of UEs within the cell, whilst a neighbouring home base station cell is underloaded.

### SUMMARY

The inventor proposes a method of load distribution between a first base station and a second base station comprises determining in a user device, that the first and second base stations are simultaneously within range of the user device; and setting that user device as a bridge; providing load factors and available resources of each base station within range of the bridge user device, whereby a first, less loaded base station increases its power until the power of the first base station is within a predetermined range of the power of a second, more loaded base station.

The user device may act as a dummy bridge, simply enabling the base stations to pass information through it to one another, but preferably, the user device is an intelligent bridge, wherein the load factors and available resources are provided from each base station to the user device.

Preferably, the load factor and available resources from one of the first and second base station is provided by the user device to the other of the first and second base station.

The user device can forward the information from each base station to the other, whether operating as a dummy, or an intelligent bridge, making a connection between two devices which are otherwise too far apart.

When operating as an intelligent bridge, preferably, the user device instructs the first base station to increase its power.

The user device determines what action is necessary and instructs each base station accordingly.

Preferably, the increase in power is achieved by increasing the pilot channel power.

Various methods of determining the load factor are possible, but preferably, the load factor is determined from one or more of a plurality of user devices served by the base station; aggregated amount of traffic of user devices served by the base station; or the maximum uplink power required to connect a user device with respect to the maximum power that the user device can use.

Preferably, the method further comprises the first base station requesting signal strength measurements from all user devices falling within an area of overlap of the range of each base station and setting the user device with the weakest signal as a new bridge.

Preferably, the second base station starts to reduce its coverage until the new bridge user device is also at the limit of the range to the second base station.

When operating as an intelligent bridge, preferably the user device instructs the second base station to start reducing its coverage area.

Alternatively, with a dummy bridge, the first base station instructs the second base station, via the bridge user device, to reduce its coverage.

Preferably, another user device within the coverage area of the second base station signals the second base station to stop reducing its area of coverage, if the signal from the second base station to the other user device drops below a threshold value.

This protects devices which would otherwise drop out of range of their base station when the method is applied.

Various methods can be used to signal this, but typically, the signalling is via power control.

The choice of which user device in the overlapping area is bridge can be made in various ways, but preferably, the bridge user device is the first user device to signal the first and second base stations.

Preferably, the first and second base stations are user installed base stations with a default coverage area set at less than 100% of their total available power.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 illustrates a home base station and a user device arrangement to which the method of load distribution proposed by the inventor is applied;

FIG. 2 shows a signalling sequence chart for a first aspect of the proposed method; and,

FIG. 3 shows a signalling sequence chart for a second aspect of the proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The concept of home base stations is fairly new and little research has been dedicated to resolving problems concerning interaction of neighbouring home base stations. In existing macro networks a radio network controller (RNC) acts as a central radio resource management (RRM) server, whereby measurements from multiple cells are compared and cell radio parameters adjusted under RNC control. However, use of an RNC is not appropriate to the home base station scenario as layer 2 (L2) functions must be located at the home base station in order to deal with local application requirements and avoid the limitations of broadband backhaul. Furthermore, the use of a centralised RRM server, as has been proposed in Long Term Evolution (LTE), is also inappropriate as the centralised server is not scalable to the high numbers of home base stations that are anticipated.

One proposal is that a home base station can act temporarily as a user device, or user equipment (UE) to make environmental measurements, but this does not address the ‘hidden cell problem’ i.e. the possibility that adjacent home base stations may not be visible to each other, but that a UE may see both base stations and hence be subject to interference from both.

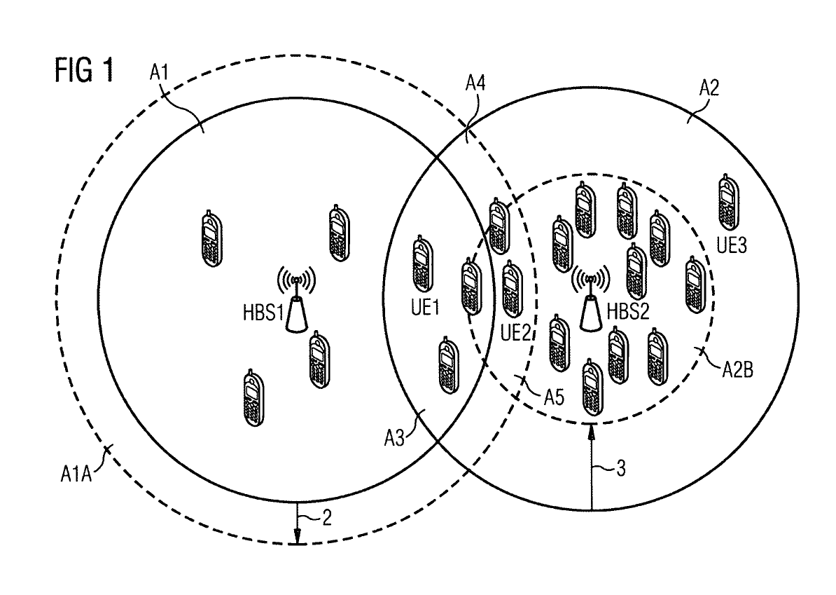

The example of FIG. 1 illustrates the proposed method applied to a UMTS network formed by two home base stations (HBS) HBS1, HBS2 and a plurality of UEs showing how cell coverage optimisation and load balancing can be carried out in networks employing HBSs. Each HBS has a default cell area A1, A2 radiating from the HBS. This default is typically the same for any HBSs sourced from the same operator, although the operator could choose to provide different basis coverage types, e.g. to suit terraced and detached homes. In this example, A1 and A2 are the same.

Within default cell area A1, there are only a few UEs, whereas in area A2 there are a large number, clustered about HBS2. There is a portion A3 of the cell area where A1 and A2 overlap due to the fact that no network planning is performed when deploying home base stations. Furthermore, the cluster of UEs around HBS2 results in HBS2 experiencing a very high traffic load due to the high number of UEs connected to it. By contrast HBS1 experiences a low traffic load, as there are few UEs trying to connect.

To address the problems of network planning optimisation and of load balancing described above, a UE UE1 in the overlapping area A3 is used as a bridge between the two HBSs. UEs located in the overlapping cell area between HBS1 and HBS2 can receive signals from both base stations. Data relating to the load factor and resources available, i.e. available increase of coverage in terms of pilot channel power used against max power allowed, of HBS1 and HBS2 is obtained and used to determine which HBS should increase its coverage and which should reduce its coverage, so that the load is shared more equally between them.

This control can be achieved in two ways. The first is UE centred, i.e. most of the information, or decisions, are processed, or taken, by the UEs involved. The second is base station centred, i.e. the UE only provides bridging functionality between base stations and information, or decisions, are processed, or taken, by the base stations involved. The latter solution enables legacy terminals to use the home base station network provided that they undergo a software upgrade.

The basic principle of the proposed method is that the base station which is more heavily loaded reduces its coverage, after the more lightly loaded base station has increased its coverage, so that the demand on resources is more evenly balanced. This can be seen in FIG. 1, where area A1 increases to area A1A via cell expansion 2, so that additional UEs are included. The UE UE2 in area AA with the weakest signal to HBS1 is set as a new bridge and then area A2 is reduced to A2B via cell restriction 3, so that HBS2 now deals with fewer UEs. If, at any stage in this process, a UE UE3 on the edge of cell A2 determines that it has reached a minimum signal strength to HBS2, then it uses power control to prevent the cell A2 from shrinking any further.

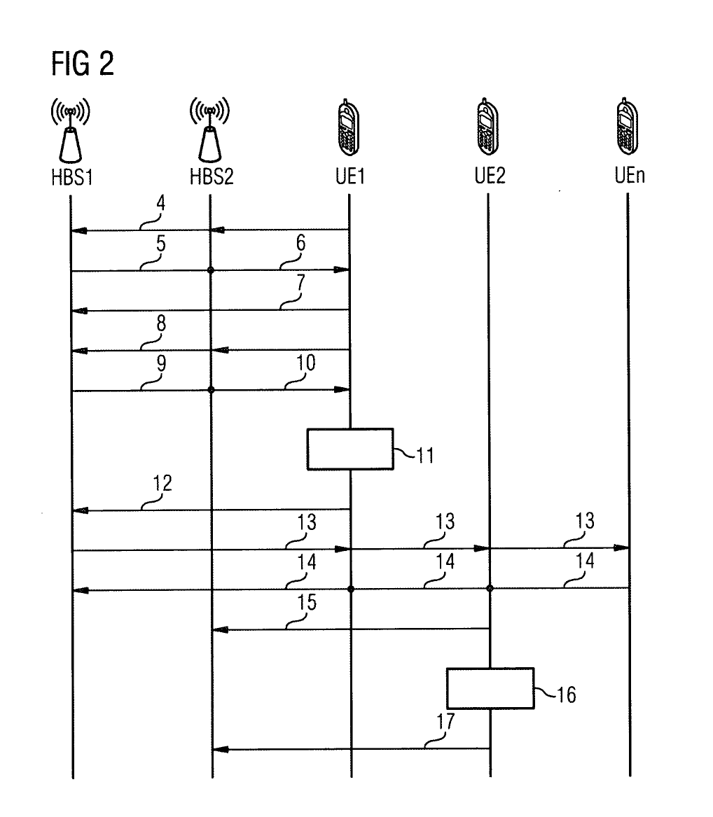

FIG. 2 illustrates the method in more detail for a first embodiment by a signalling sequence chart for a UE centred solution. Triggered by a randomly timed start process one of the UEs UE1 starts communicating with both base stations HBS1, HBS2 asking them to send 4 certain parameters, such as their load factor, i.e. an indication of the radio resources employed by the connected UEs, and their current cell coverage as a percentage of the maximum achievable coverage. HBS1 and HBS2 send their respective load factor and coverage data 5, 6 to UE1 and UE1 communicates to both base stations the identity of their neighbour base station.

UE1 realises that HBS2 is underloaded and has scope to expand its coverage while HBS1 is overloaded. This situation may well occur since the home base stations are initially set to a default coverage, e.g. the average size of a house, which is smaller than their maximum coverage and the distribution of users is unlikely to be uniform. UE1 requests 7 that HBS1 gradually increase its coverage, shown as cell expansion 2 in FIG. 1. This is typically done by increasing the pilot channel power. Also, UE1 requests 8 that HBS1 and HBS2 periodically provide their traffic load factor and this is returned 9, 10 by each HBS. The bridge UE aims to get both traffic loads within a predetermined range, so that when UE1 detects 11 that the traffic load of HBS2 has decreased below a predetermined threshold, the UE requires 12 that HBS1 stops increasing its coverage.

At this point of the procedure an overlapping cell area A4 between HBS1 and HBS2 is at its maximum. HBS1 broadcasts a request 13 for all UEs from UE1 to UEn that can see both HBS1 and HBS2, i.e. in area A4, to report their received signal strength. After the UEs reply 14, HBS1 selects the UE with the lowest signal strength, which is UE2 in FIG. 1, to be the new bridge UE. UE2 then asks 15 HBS2 to decrease its power until the signal strength of HBS2 at UE2 reaches a minimum threshold as indicated by cell restriction 3 in FIG. 1. Having verified 16 that the signal strength from HBS2 is at its lowest threshold, UE2 then instructs 17 HBS2 to stop lowering its coverage.

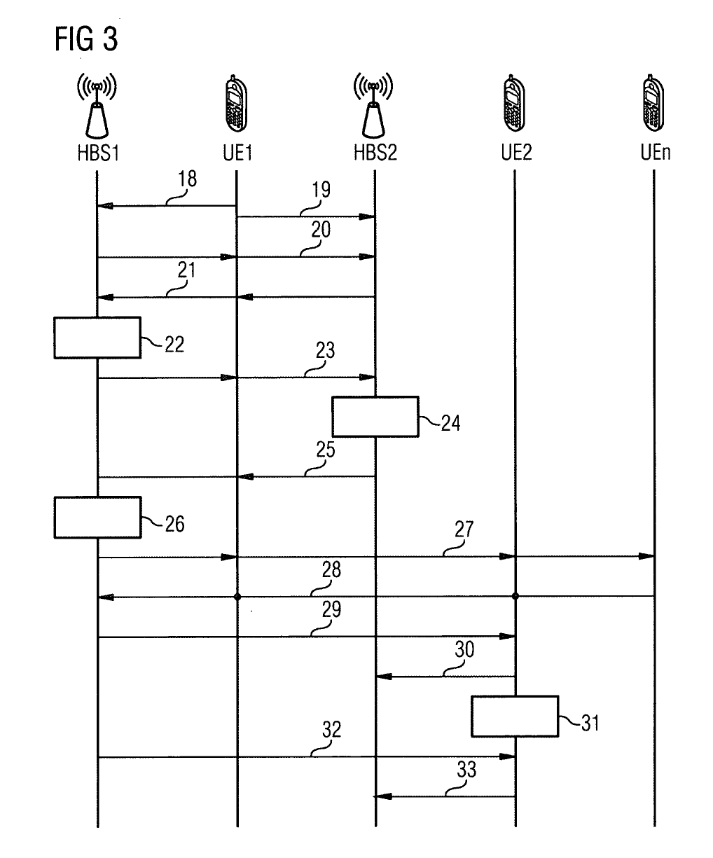

In a second embodiment, the UE acts purely as a bridge, but does not control the message flow between the HBSs. This is shown in more detail in FIG. 3. A group of UEs located in the overlapping cell area A3 between HBS1 and HBS2 can receive signals from both base stations. Triggered by a randomly timed start process, one of these UEs, typically the first UE to signal the HBS, e.g. UE1, communicates to HBS1 that it can receive signals from HBS2 and to HBS2 that it can receive signals from HBS1, by sending a notification 18, 19 of signal reception from both base stations.

HBS1 sends 20 its load factor, i.e. an indication of the radio resources employed by the connected UEs, and its current cell coverage as a percentage of the maximum achievable coverage to HBS2 via UE1. HBS2 sends 21 its load factor, i.e. an indication of the radio resources employed by the connected UEs, and its current cell coverage as a percentage of the maximum achievable coverage to HBS1 via UE1. UE1 acts as a bridge between HBS1 and HBS2. Both base stations realise that HBS2 is underloaded and has scope to expand its coverage while HBS1 is overloaded. Therefore, HBS1 increases 22 its coverage by a predefined amount and enquires 23 of HBS2, via UE1, about the load factor after the increase. If the load factor of HBS2 has reduced such that it is within predefined limits, then HBS1 stops increasing its coverage, otherwise this process iterates until the load factor of HBS2 reaches the prefixed threshold. HBS2 then sends 25 its load factor to HBS1 and HBS1 stops 26 increasing its coverage.

At this stage of the procedure HBS1 selects UE2 in the same way as for the UE centred solution, i.e. HBS1 broadcasts 27 a request for all UEs, UE1 to UEn, that see both HBS1 and HBS2 to report their received signal strength and these UEs return 28 their signal strength values. HBS1 selects the UE with lowest signal strength, i.e. UE2 in the example of FIG. 1, to be the new bridge. This selection implies a change in the bridging UE. At this point HBS1 requests 29, 30 via UE2, that HBS2 starts to decrease its coverage, shown as cell restriction 3. Once HBS2 signal strength received by UE2 has been verified 31 as reaching a predefined lower threshold, HBS1, via UE2, requests 32, 33 that HBS2 stops decreasing its coverage.

In both procedures described above, the final result achieved is that the overlapping area A5 between HBS1 and HBS2 is minimised and the load (i.e. attached UEs) is distributed in a balanced way between the two base stations.

One advantage of the method is that effective control of adjacent home base stations can be achieved. Communications between adjacent base stations are made possible through the UE which avoids the need for network side communication links, i.e. it is achievable over-air. The method avoids the need to establish additional network nodes, which would increase the capital and operational expenditure of the operators. As the solution is effectively distributed across the home base stations it is also scalable with the size of the network.

Furthermore, optimisation of home base station coverage is enabled by resolving the problem of large overlapping areas between adjacent cells. This problem is due to home base station deployment not undergoing the process of network planning that is usually applied to network base stations.

In addition, the proposed method helps to distribute the traffic between home base stations. Such traffic could be unevenly distributed and disproportionately overload a home base station, whilst neighbour home base stations are underloaded. The operators are able to set up traffic load thresholds on home base stations and to make sure that traffic load is below such threshold. Such a mechanism of load balancing allows automatic adjustment of cell size depending on user density in the cell area.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A method of load distribution between a first base station and a second base station, comprising:
determining in a user device, that the first and second base stations are simultaneously within range of the user device, the first base station being less loaded than the second base station;
setting the user device as a bridge for communicating load factors and available resources such that with the bridge at least one of the first base station, the second base station and the user device is provided with load factors and available resources of both the first and second base stations; and
based on the load factors and available resources communicated via the bridge, deciding to increase power at the first, less loaded base station until the power of the first base station is within a predetermined range of a power of the second base station.

16. A method according to claim 15, wherein the load factors and available resources are provided from each base station to the user device.

17. A method according to claim 15, wherein the load factors and available resources from one of the first and second base stations are provided by the user device to the other of the first and second base stations.

18. A method according to claim 15, wherein the user device instructs the first base station to increase its power.

19. A method according to claim 18, wherein the increase in power is achieved by increasing pilot channel power.

20. A method according to claim 15, wherein the load factors are determined from one or more of:
number of user devices served by the base station;
aggregate amount of user device traffic being served by the base station; and
maximum uplink power required to connect a taxed user device to the base station versus the maximum power that the taxed user device can use.

21. A method according to claim 15, further comprising:
requesting signal strength measurements at the first base station from all user devices falling within an area of overlap between the first and second base stations;
determining which user device within the area of overlap has the weakest signal; and
setting the user device with the weakest signal as a new bridge.

22. A method according to claim 21, wherein the second base station reduces its coverage area until the new bridge user device is at a weak signal range limit for the second base station.

23. A method according to claim 22, wherein, after being set as the new bridge, the new bridge user device instructs the second base station to start reducing its coverage area.

24. A method according to claim 22, wherein the first base station instructs the second base station, via the new bridge user device, to reduce its coverage.

25. A method according to claim 22, wherein another user device within the coverage area of the second base station signals the second base station to stop reducing its coverage area, if a signal from the second base station to the other user device has a signal strength that drops below a threshold value.

26. A method according to claim 25, wherein the other user device signals the second base station via power control.

27. A method according to claim 15, wherein
all user devices that are simultaneously within range of both the first and second base stations signal the first and second base stations, and
the bridge is set to the user device that is first to signal the first and second base stations.

28. A method according to claim 15, wherein the first and second base stations are user-installed base stations with a default coverage area set at less than 100% of their total available power.

29. A method according to claim 16, wherein the load factors and available resources from one of the first and second base stations are provided by the user device to the other of the first and second base stations.

30. A method according to claim 16, wherein the user device instructs the first base station to increase its power.

31. A method according to claim 30, wherein the increase in power is achieved by increasing pilot channel power.

32. A method according to claim 31, wherein the load factors are determined from one or more of:
number of user devices served by the base station;
aggregate amount of user device traffic being served by the base station; and
maximum uplink power required to connect a taxed user device to the base station versus the maximum power that the taxed user device can use.

33. A method according to claim 29, wherein the load factors are determined from one or more of:
number of user devices served by the base station;
aggregate amount of user device traffic being served by the base station; and
maximum uplink power required to connect a taxed user device to the base station versus the maximum power that the taxed user device can use.

34. A method of load distribution between a first base station and a second base station, comprising:
determining in a user device, that the first and second base stations are simultaneously within range of the user device, the first base station being less loaded than the second base station;
setting the user device as a bridge for communicating load factors and available resources such that with the bridge at least one of the first base station, the second base station and the user device is provided with load factors and available resources of the first and second base stations; and
increasing power at the first, less loaded base station until the power of the first base station is within a predetermined range of a power of the second base station, wherein
the first and second base stations are connected to a network, but have respective cell coverage areas that are not adjusted by the network.
